(19) United States
(12) Patent Application Publication
(10) Pub. No.: US 2006/0122900 A1
(43) Pub. Date: Jun. 8, 2006

(54) System for and method of information management

(76) Inventors: Damien Paul Bean, Beverly Hills, CA (US); Robert Frank Taylor III, Collierville, TN (US)

Correspondence Address: CHRISTIE, PARKER & HALE, LLP, PO BOX 7068, PASADENA, CA, 91109-7068, US

(21) Appl. No.: 11/286,115

(22) Filed: Nov. 23, 2005

Related U.S. Application Data
(60) Provisional application No. 60/630,967, filed on Nov. 24, 2004.

(51) Int. Cl. G06Q 30/00

(52) U.S. Cl. 705/26

(57) ABSTRACT

A method of, and system for managing and storing items of information, including receiving items of information from a plurality of content providers, and distributing items of information to a plurality of users are described. In one aspect of the invention, a user is identified, a user account created, a request to purchase an item of information is received, the user's comprehension of the item is assessed, the item is evaluated, and the user's account is updated. One embodiment includes a system having a record server, a content server, an evaluation server, and a pricing server, all in communication with one another, where the system is accessed through a system interface remote from the servers, configured to allow users to access the system, request and receive items of information, submit assessment data, submit evaluation data, and upload items of information.

### CROSS-REFERENCE TO RELATED APPLICATIONS

This application claims the benefit of U.S. Provisional Patent Application No. 60/630,967, filed Nov. 24, 2004, the contents of which are expressly incorporated herein by reference in its entirety.

### BACKGROUND

The present invention relates to computer-based information management system, comprising interactive compilation, management, storage and distribution of information to and from a plurality of users.

In one aspect, the invention is a computer-based learning management system. In one aspect, it is a repository of intellectual property, facilitating improved access to learning materials. In short, those seeking training are provided with increased selection and quality while those providing content are given access to a larger and more diverse audience. In addition to facilitating such improved communication, another aspect of the invention is to maintain database records pertaining to users, to content available, and to courses completed by users. The invention provides access to, and coordinates communication between multiple servers, while also implementing record keeping of all training, and providing a cost structure that allows organizations to purchase selected quantities of material. Because of the level of detail provided by the invention, a large administrative burden is offloaded from the participating organization. The invention provides an improved learning management system that provides an open environment, supporting life long learning strategies through self administration and empowerment, transportability, and ease of use.

Previously, learning management systems have effectively been closed, single company environments often based on use-specific hardware and software. Such systems quickly grow stale and outdated, reducing interest and effectiveness. Such systems also typically require a significant capital investment. The addition and updating of content was also a costly and time-consuming endeavor. Further, while such systems may, for at least a time, provide a minimum level of employer-provided learning, they lack transportability, or “stickiness” with respect to the individual users. Rather than provide education through a closed system that is specific to a particular enterprise, the present invention makes the implementation and management of employee education transportable, in that an employee can still access a record of prior courses even after leaving the particular enterprise. Such stickiness not only provides a lasting record for the user, transportable to various employment contexts, but also provides real substance to an employer's claim of training as an investment in its employees.

The present invention provides such a learning management system that “sticks” with the individual users, meaning that it is transportable with them, whether to various locations within the same enterprise, or even at a different enterprise altogether. The system provides greater value and flexibility to the employer, with an ever-expanding menu of content, and provides greater value and flexibility to the individual employee users, with the knowledge that the training they obtain truly is an investment in their future, and records of such training will remain with the employee indefinitely. This also provides additional motivation to the individual employees to participate in the learning system. The present invention provides an open learning environment beneficial to both employers and employees. Users are able to more easily keep track of their own training, while employers are more able to implement enterprise-wide training and maintain an accurate records of such efforts.

### SUMMARY OF THE INVENTION

Embodiments of the present invention include a method for providing selected users access to selected information. A content server for storing a plurality of items of information is provided. A plurality of users, remote from the content server, are identified. For each user identified, a user account is created on the pricing server, including user data. Users are provided access to a database of items of information stored on the content server that are available to that specific user, based on user data in the user's account. A request to purchase at least one item of information is received from at least one specific user, the request including user data. The identity of the specific user is verified based on user data included in the request. Further, the specific user's entitlement to purchase the requested item of information is also verified based on user data. The specific user is provided access to the purchased item of information for a predetermined temporal period. The specific user's access to the requested item of information is confirmed. The specific user is requested to provide certain information relating to the purchased item of information. Certain information relating to the purchased item of information is received from the specific user. Assessment data is generated based on the information received from the user. The assessment data is stored on the record server. The specific user is requested to provide evaluation data relating to the purchased item of information. Evaluation data relating to the purchased item of information is received from the specific user. The received evaluation data is stored on an evaluation server. Data relating to the specific user, the purchased item of information, and the specific user's access to the item of information are stored on the record server. The specific user's account is updated based on at least one of: the purchased item of information, the specific user's access to the item of information, the specific user's assessment data, and the specific user's evaluation data.

In another embodiment, cost data is assigned to each item of information.

In a further embodiment, the cost data is stored on a pricing server.

In still another embodiment, an account balance is linked to a user through the user's account.

In a yet further embodiment, the account balance of a user is debited based on a user's purchase of an item of information and the cost data for the item.

In yet one more embodiment, the account balance of a user is updated based on a user's purchase of an item of information.

In another embodiment, the database of items of information stored on the content server is linked to evaluation information relating to the items of information stored on the evaluation server.

In another embodiment, items of information are received from users, and stored on the content server.

In a further embodiment, a template is provided for users to create items of information.

In a still further embodiment, a request is received from a user to provide selected user data to a remote server.

In yet another embodiment, selected user data is provided to a remote server.

In still another embodiment, user data is received from a remote server.

In yet one more embodiment, users are provided a database of available content, searchable by at least one of the following: subject matter, author, certification, popularity, evaluation score, and cost.

In a further embodiment, at least one user is provided access to a searchable database of items of information not stored on the content server.

Another embodiment includes a method of managing and storing items of information, including receiving items of information from a plurality of content providers, and distributing items of information to a plurality of users. A content server is provided. A plurality of content providers, remote from the content server, are identified. For each content provider identified, an account is created on a pricing server, including content provider data. An item of information is received from at least one content provider. The received item of information is stored on the content server. The account for the specific content provider is updated, including data relating to the received item of information. A plurality of users, remote from the content server, are identified. For each user identified, an account is created on the pricing server, including user data. Each user is provided access to a database of items of information stored on the content server that are available to that specific user, based on user data in the user's account. A request to purchase at least one item of information is received from at least one specific user, the request including user data. The identity of the specific user is verified based on user data included in the request. The specific user's entitlement to purchase the requested item of information is verified. The specific user is provided access to the purchased item of information for a predetermined temporal period. The specific user's access to the purchased item of information is confirmed. Certain information relating to the purchased item of information is requested from the specific user. Certain information data relating to the purchased item of information is received from the specific user. Assessment data is generated based on the information received from the user. The assessment data is stored on the record server. Evaluation data relating to the purchased item of information is requested from the specific user. Evaluation data relating to the purchased item of information is received from the specific user. The evaluation data is stored on an evaluation server. The account of the specific user is updated, including storing data relating to at least one of: the purchased item of information, the specific user's access to the item of information, the specific user's assessment data, and the specific user's evaluation data.

Yet another embodiment includes a system for managing and storing items of information, including receiving items of information from a plurality of content providers, and distributing items of information to a plurality of users. A record server, having data relating to users and content providers, including assessment data, a content server, having items of information, an evaluation server, having evaluation data received from users and content providers, and a pricing server, having data relating to the accounts of users and content providers, and data relating to the cost of the items of information, are all in data communication with one another, and remote from the content providers and the users. A system interface is physically remote from the servers, but coupled to the servers by a network, and is configured to allow selected users and content providers to access the system, to search the data of the record server, to search the data of the content server, to request, purchase and receive items of information, to submit assessment data to the record server, to submit evaluation data to the evaluation server, and to upload items of information to the content server.

In yet one more embodiment, the system interface includes a conditional access system that allows selected users access to the system only after verification of certain user data in the user's account.

In another embodiment, there is a data connection between the record server and an outside server.

In a further embodiment, data is transmitted from the record server to the outside server.

In still another embodiment, there is a system administrator with data connections to the record server, the content server, the evaluation server and the pricing server.

### BRIEF DESCRIPTION OF THE DRAWINGS

FIG. 1 is a schematic view of an information management system in accordance with an embodiment of the present invention.

FIG. 2 is a high-level flow chart showing the steps of a method of providing selected users access to selected information in accordance with an embodiment of the present invention.

FIG. 3 is a high-level flow chart showing the basic steps of a method of managing and storing items of information, including receiving information from a plurality of content providers, and distributing information to a plurality of users in accordance with an embodiment of the present invention.

### DETAILED DESCRIPTION OF THE INVENTION

Turning now to the drawings, embodiments of the present invention are illustrated that include a system for and method of managing and storing items of information, including receiving items of information from a plurality of content providers, and distributing items of information to a plurality of users.

The present invention provides a platform for providing a wide variety of information, sometimes referred to in the application as content, courses, coursework, course materials, curriculum, or items of information, through a networked content server, record server, evaluation server and pricing server, accessible, through remote terminals via a system interface to a plurality of individuals, including users, content providers, human resources personnel, third party sponsors, and system administrators, each of whose access is controlled based on information stored in a user account. System administrators also have direct access to the servers. The curriculum is kept perpetually current, as content providers upload new content to the server, allowing users to select from an ever-expanding variety on curriculum. In a preferred embodiment, the system is used to provide educational coursework to employees on a variety of topics, from company procedure training, to state and federally mandated courses. The system maintains a record for each user of all such coursework taken.

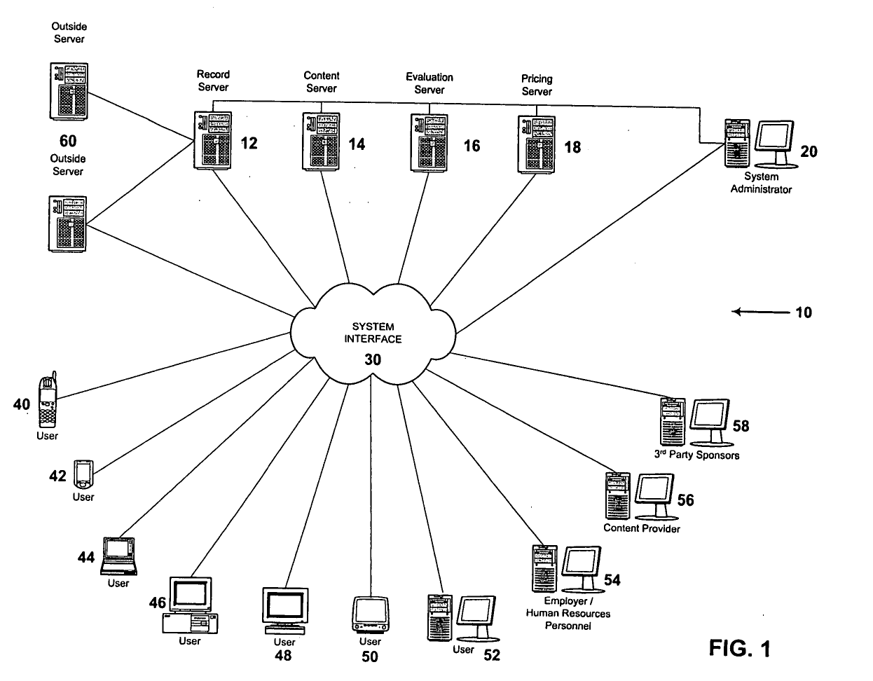

As shown in FIG. 1, the system 10 includes a record server 12, a content server 14, an evaluation server 16, and a pricing server 18. In general, record server 12 contains user data related to complete courses and certifications; content server 14 contains the items of information, or content; evaluation server 16 contains evaluation data from users and content providers; and pricing server contains accounts for users and content providers. While shown as physically separate servers in FIG. 1, it will be appreciated by those skilled in the art that in another embodiment, the servers are four virtual servers on a single physical device. In addition, in yet another embodiment, each of the four servers (record, content, evaluation and pricing) is a virtual server comprising more than one physical device. In a yet further embodiment, each virtual server is comprised of more than one physical device, where at least one physical device is remote from the remaining physical devices of the particular server. In the embodiment shown in FIG. 1, a system administrator 20 is networked directly to each of the four servers. The four servers are linked to a system interface 30, which further links the systems to a plurality of users 40, 42, 44, 46, 48, 50, 52, to human resources personnel, 54, to content providers 56, and to third party sponsors 58.

Through system interface 30, users access the system 10. As illustrated, users may access the system through a variety of network capable terminal devices, such as cellular phones (user 40), PDAs (user 42), laptop computers (user 44), or a variety of home and/or business computers (users 46, 48, 50, 52). Regardless of the terminal device used, the user accesses the system interface 30, or portal. By using a common system interface, ease-of-use of the system is increased, such that regardless of the terminal device used to access the system, obtaining access to and navigating the system will appear substantially similar, providing users with a familiar look. The users are remote from the servers 12, 14, 16, 18, and access the system through the system interface 30. For example, from a location remote from the servers, a user, using a compatible network capable terminal device, such as a laptop computer, accesses the system interface 30. In a preferred embodiment, a user accesses the system interface at a specific IP address or URL on the Internet, using a standard Web browser, thereby reaching the system interface 30 which displays on the user's terminal. The user then uses the system interface 30 to access the system, including viewing available content, purchasing content from the system, viewing the user's account, viewing the user's record of courses, or uploading content to the system. As used in this application, the term “purchase” includes a user's request to access or view a particular item of information, whether or not such request has any cost associated with it. In short, after locating an item of information through the database, any request for further access to such item of information is considered a “purchase.” In some embodiments, a purchased item may be viewed by the user. In other embodiments, a purchased item may be downloaded by the user. In yet another embodiment, a purchased item may be copied to a device for use offline. In still another embodiment, the system operates completely within an enterprise network, such as a corporate intranet.

The pricing server 18 houses data relating to specific users and content providers. User accounts are created and stored on the pricing server. As used in the application, content providers are simply a specific subset of users: users are typically those who use the system to access particular items of information, such as an educational course, while content providers are those users who typically access the system to upload items of information, such as a educational course that they have authored. Reference to a “user” therefore could also include a “content provider.” Accounts are created for both users and content providers, and include data about the particular user or content provider. Accounts are created in a variety of ways. First, an account may be created through the system administrator 20.

The present system is often deployed in an enterprise where easy access to training and educational materials is required. This varies from in-house corporate training, to coursework mandated by state or federal law. In such an embodiment, the enterprise, or employer, typically has a number of employees which it would like to become users of the system. In such an embodiment, accounts are typically created by human resources personnel 54 for each user (employee). The human resources personnel access the system through the system interface 30, using a terminal of their choice, such as their desktop computer. Using the interface, accounts for individual users are set up. User account data is stored on the pricing server 18. Additional user data is stored on the record server 12. Because there is some overlap of information, such as user name, there is some duplication of information between the pricing server 18 and the record server 12. In a preferred embodiment, the system automatically transfers necessary information from a user's account on the pricing server 18 to the user's data on the record server 12.

The employer may choose to set up individual user/employee accounts for any number of employees. In a preferred embodiment, account setup has been simplified to allow the employer to setup multiple accounts in batches. Such accounts require the employer to provide certain predetermined information for each account to be set up. This information is stored on the pricing server 18. In one embodiment, accounts are set up in a hierarchal system, first grouped by a unique identification code assigned to the sponsor/employer, then utilizing a second unique identification code unique to the particular employee. In one embodiment, account access information, such as a username and password, is provided to each user for which an account is created.

In another embodiment, users are members of organization, which sponsors content for its members. Again, like an enterprise setting up accounts for its employees, the organization may choose to set up accounts for its members. In another embodiment, the organization may provide a code or link to allow its members to set up their own accounts.

In a further embodiment, a user who is already a user of the system, and has an account set up through a first sponsor, is also associated with a second sponsor. In that case, the user can log onto his or her account, and update the account to reflect the additional sponsorship. Alternatively, the second sponsor may also provide sponsorship information to the system, which will automatically update the user's account to reflect the dual sponsorship. Such dual sponsorship will likely make additional content available to the user. In another embodiment, the user's single account displays separate account balances from each sponsor.

Once a sponsor/employer creates an account for an employee, the employer determines the balance that will be provided to the particular account. Each course, or particular content provided on the system, is assigned a “cost.” This information is stored on the pricing server 18.

The user accesses the system through the system interface 30, using a terminal of the user's choice, such as a laptop computer (user 44). In a preferred embodiment, the system interface 30 provides the user the ability to search through available items of information. In one embodiment, an electronic catalog of available content is made available to users. Such catalog is searchable in a variety of ways, including based on subject, content provider, certification, popularity, evaluation score, and price. For example, if an employee has previously used materials prepared by a Dr. Smith, or seen a presentation by Dr. Smith, that employee may search to find additional materials authored by Dr. Smith. As a further example, an employer may require all employees to take two hours of training on a particular subject. The system database may offer 20 hours of material on that subject. The employee is then empowered with the ability to choose the material to fill the requirement, and using the previous example, may choose two hour-long seminars by Dr. Smith, based on previous experience with Dr. Smith's material. In that way, employees are allowed to fulfill training requirements while still exercising their own choice.

In one embodiment, the catalog of content also provides certification information, so that for any particular course, all certifications for which the course would qualify would be listed. In addition, completion of such coursework is also reported to the appropriated certification body as required to maintain the user's certification. In addition, a sponsor/employer would also have access to determine which of employees had completed required certified courses, and which, if any, required additional certified courses to maintain their certification.

In one embodiment, the user is only shown items of information which the user is eligible to purchase. In another embodiment, the user is shown all content on the content server, but may only purchase such items which the user is purchase to select. Eligibility to purchase a particular item is determined by user data in the user's account on the record server, as well as user data in the pricing server. When a user chooses to purchase a particular item of information, the “cost” associated with that item is deducted from the user's account. As noted above, even if no cost is associated with a particular item of information, a user's request for access to the particular item of information is deemed a “purchase.”

Although the user selects the item to access through the system interface 30, the system obtains cost and pricing information from the pricing server 18. Once a user purchases particular item, and the cost is deducted from the user's balance, the pricing server 18 communicates with the content server 14, directing the content server 14 to provide access to the particular user for a predetermined amount of time. As shown below, the system also coordinates with the records server and evaluation server. In a preferred embodiment, after purchase, a user is provided access to the content for 30 days. Many of the items of information available are in the form of an educational course. During the predetermined period for which access is granted to the user, the user is expected to complete the course.

Upon completion of the course, the user is requested to provide responses to certain questions. In a preferred embodiment, the system prompts the user to answer a series of questions designed to test the user's comprehension and understanding of the purchased item or course. The user answers the questions, and the system generates assessment data based on the user's responses. The assessment data is stored on the record server 12. In another embodiment, the user is prompted to provide responses throughout the course, such as questions at the end of each chapter, in order to generate assessment data.

In one embodiment, the assessment data is interactive within the content, in the form of a test to be administered to a user. In one embodiment, the system can administer standardized tests, such as many state or county required examinations, or other standardized tests such as the SAT, LSAT, MCAT, and GRE. In a further embodiment, the system is used to provide study courses for such standardized tests.

The user is also requested to provide evaluation data. In a preferred embodiment, the system prompts the user to evaluate the purchased information. The system collects this information from the user, and stores it on the evaluation server 16. In a preferred embodiment, a first user's evaluation data regarding a particular item of information is accessible to other users prior to accessing the particular item of information, in much the same way that a moviegoer may check reviews prior to determining which movie to see. Again, while the user's access is completely through the system interface 30, the system coordinates access to the evaluation server 16 with access to the pricing server 18 for “purchase” of the content, and with access to the content server 14 to provide the selected item of information. Once both the course and the evaluation have been completed, the content and evaluation servers coordinate with the record server 12 to reflect completion of the course.

Although the system is most typically used in an enterprise environment, where an employer “sponsors” employees by creating accounts for them, providing them a predetermined account balance, and a selection of items which the employee is eligible to purchase, the system is not limited to such use. In another embodiment, a third party sponsors individuals in a similar manner. In yet another embodiment, the third party sponsors individuals by providing a code or link which the individuals may use to create their own account through the system interface 30. In one embodiment, a user may be “sponsored” by multiple sponsors. The user still accesses the system in the same manner, such as through a username and password, but the user's account is updated to reflect multiple sponsorship, so the user will be granted access to content from the various sponsors, all through the single login. For example, a user is a member of an enterprise, which sponsors its employees for selected content, called Group A. The user is also a member of a professional organization, which sponsors its members for selected content, called Group B. The user, now sponsored by both the enterprise and the professional organization, logs into the system once, with the same account access information, but is automatically provided access to content in both Group A and Group B.

In one embodiment, a sponsor/employer may limit the courses available to a particular employee. First, employers may provide confidential and/or proprietary training materials for use only by its own employees. It may also allow its employees access to other materials. In another embodiment, an employer may also choose to make some of its own content publicly available to other users. Typically, an employer will provide an employee with a specific account balance, sufficient to cover purchase of all required training courses. In yet one more embodiment, the employer may also provide additional balance for the employee to select additional “elective” courses.

Access to the system for users, as well as employers/human resources personnel and third party sponsors, is through system interface 30, using a compatible terminal device of their own choosing. Based on the user account of the individual accessing the system, the system provides “conditional access” to users of different levels. The parameters of such conditional access vary by application, and may be changed by the system administrator 20. In a typical embodiment, human resources are granted access to the accounts of all of their company's personnel, or those within a particular department. A single user, an employee of a particular company, however, would typically only be granted access to his or her own account. A third party sponsor may be granted access only to limited information in user's account which pertain to that sponsor, or to items accessed that were provided by such sponsor.

The system stores user data in user accounts on the pricing server 12. Such information includes identity of the user, relation to any particular sponsors or employers, user's account balance, account settings, and the user's access to particular courses. User data relating to the user's completion and assessment of various courses is stored on record server 12. In a preferred embodiment, this user information on the record server is transportable with the user. For example, if a user takes courses using the system while working for employer A, then moves and goes to work for employer B, the user would still be able to access the system to review the record of previously completed coursework.

In another embodiment, the record server 12 communicates with outside servers 60. Outside servers are servers outside of the claimed system. In one such embodiment, the outside servers represent compliance, regulatory and/or certification bodies, such that the system automatically provides a record of completion of necessary courses by users. In a further embodiment, the system communicates with outside servers to determine course requirements for a particular user, and also provides a certified record of completion of such requirements electronically to the outside server, as well as maintaining the records on the record server. It will be appreciated by those skilled in the art that many professionals in the financial, legal and medical fields are required to complete mandatory continuing education requirements. In addition, many states require all personnel in supervisory positions to complete certain levels of training. In a preferred embodiment, the present system obtains such requirements from outside servers, applies such requirements to appropriate users through the user data in the record server, reminds such users and their employers of such requirements, and monitors progress toward and/or completion of such requirements.

In another embodiment, compliance, regulatory and certification bodies are given user accounts on the system, to review and approve content on the system, and access the content in the same manner as users, through system interface 30. In a further embodiment, the approval or certification is given online through the system interface 30. In another embodiment, the approval or certification is conveyed to the system administrator 20, which modifies the relevant content in the content server 14 to reflect such approval and/or certification. In addition, if such approval and/or certification is retroactive to cover previously purchased content, the relevant records in the record server 12 are also modified.

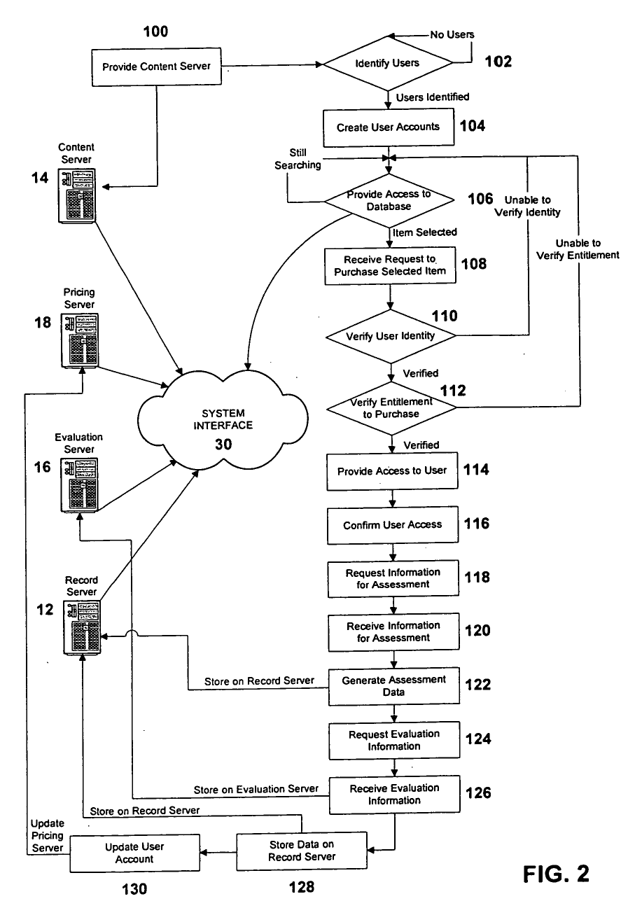

Moving now to FIG. 2, the method illustrated includes the step (100) of identifying a content server 14. Users are identified (102.) If users are successfully identified, user accounts are created for those users (104). Users with accounts are provided access to the database (106). This access to the system 10, and more particularly to the content server 14, is through the system interface 30. When an item is selected for purchase, a request is received from a user to purchase the selected item (108). The identity of the user is then verified (110). If unsuccessful, the user is prompted to select another item (106). If the user's identity is successfully verified (110), the user's entitlement to purchase the particular item is verified (112). Again, if unsuccessful, the user is prompted to select another item (106). If entitlement to purchase is successfully verified, the user is provided access to the purchased item (114). User access to the purchased item is confirmed (116). Upon completion of the course, the user is requested to provide information (118). The requested information is received from the user (120), and assessment data is generated (122). The assessment data is stored on the record server 12. The user is then prompted to provide evaluation information (124). The evaluation information is received from the user (126), and stored on the evaluation server 16. Additional data relating to the specific user, the purchased item, and the user's access to the item is stored on the record server 12 (128). The user's account on the pricing server 18 is also updated based on at least one of the following items: the purchased item, the user's access to the purchased item, the user's assessment data, and the user's evaluation data (130).

Another aspect of one embodiment of the present invention, in addition to managing, storing and distributing information, is the system's ability to receive or compile information. While users may access information through the system interface as described above, users may also upload items of the information to the system. While these may be the same users as those accessing information from the system, those uploading information to the system are referred to as content providers. As shown in FIG. 1, content providers 56 access the system through the system interface 30, again using the compatible terminal of their choice. In one embodiment, the system interface allows a content provider to access his or her account, viewing parameters relating to courses uploaded by the content provider such as other courses by this provider, search and purchase statistics, assessment data, and evaluation data. In another embodiment, content providers are provided access to a variety of “templates” for creating content through the system interface. These include templates for textual material, audiovisual material, presentations, animations, or combinations of these.

In one embodiment, content providers, whether also sponsors/employers, or solely providers of content, are compensated each time course materials that they have provided are accessed. In another embodiment, the catalog of available content lists upcoming “live” events. For such events, the system works as described above, except that the content in the content server is a link to a live broadcast of the event, providing appropriate conditional access information within the link to allow users to purchase the item and view the event at the appropriate time.

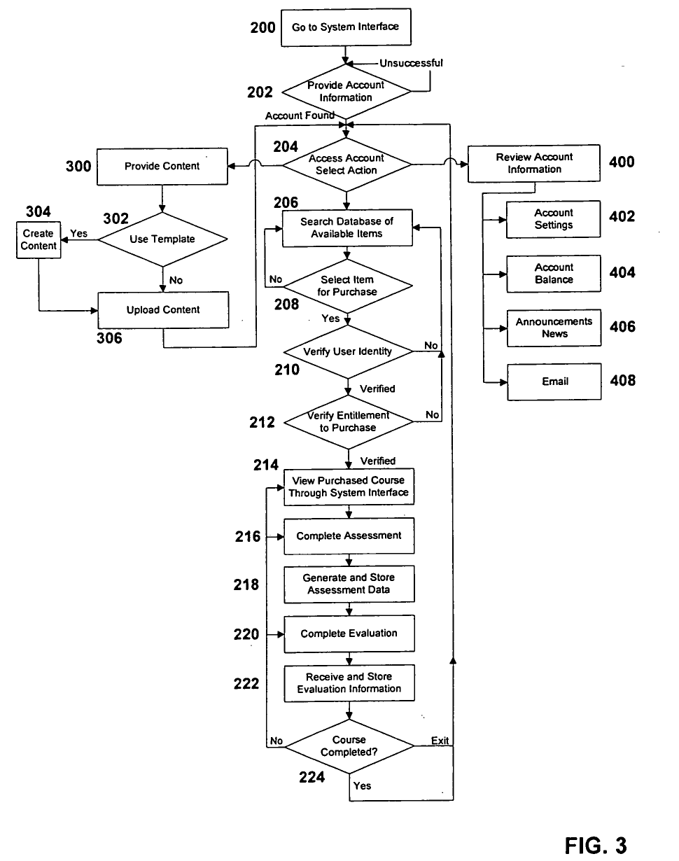

In the embodiment of the invention illustrated in FIG. 3, it can be easily seen that content may be received and distributed by the same system. A user accesses the system through the system interface 30 (200). The user “logs on” to the system by providing account information (202), such as a username or password. Those skilled in the art will appreciate that a variety of methods of logging on may be implemented without departing from the present invention. Once a user has successfully entered account information and logged on to the system, several options are presented from which the user may choose (204). If the user is content provider, the user may choose to provide content (300). Having chosen to provide content, the user may next select whether to use a template (302) provided by the system in order to create its content. If the user wishes to use the template (304), the system provides a selection of templates from which the user may choose the most appropriate one or ones, such as text, video, audio, audiovisual, presentation, animation and other templates. Upon completion of using the template, the user may upload the content (306) to the system. Similarly, should the user not wish to use a system template, the user may upload the content directly.

Going back to the selections available to the user upon accessing the account, the user may also choose to search the database of available content (206). If the user finds a desired item, it may select the item for purchase (208). The identity of the user is then verified (210), based on user data. In addition, the user's entitlement to purchase the selected item is also verified (212). Should either verification step fail, the user is returned to the selection step. After verification, the use views the purchased course through the system interface (214). After completing the course, the user is prompted to complete the assessment process (216). If completed, the assessment data is generated and stored on the record server (218). Similarly, the user is prompted to complete the evaluation process (220). If complete, the evaluation data is stored on the evaluation server (222). Should the user fail to complete either step, the user will be prompted (224) to either resume viewing the course, to complete the assessment and evaluation processes, or to exit back to the selection screen.

Going back once more to the selections available from the selection screen, the user may also choose to review account information (400). From there, the user will be prompted to select from account settings (402), account balance (404), announcements and news (406) and the user's own system email (408). It will be appreciated by those skilled in the art that in other embodiments, the selections available are changed, and may be tailored to specific applications.

While the above description contains many specific embodiments of the invention, these should not be construed as limitations on the scope of the invention, but rather as an example of one embodiment thereof. For example, account information may include user and content provider profiles. User's schedules may also be included, as well as a resume tool for compiling a user's record of training. Accordingly, the scope of the invention should be determined not by the embodiments described above or illustrated in the figures, but by the following claims and their equivalents.

1. A method of providing selected users access to selected information, comprising:
providing a content server, containing a plurality of items of information;
identifying a plurality of users, remote from the content server;
creating an account for each user, including user data, on a pricing server;
providing users access to a database of items of information stored on the content server that are available to that specific user, based on user data in the user's account;
receiving from at least one specific user, a request to purchase at least one item of information, the request including user data;
verifying the identity of the specific user based on user data included in the request;
verifying the specific user's entitlement to purchase the requested item of information based on user data;
providing access to the specific user, for a predetermined temporal period, to the purchased item of information;
confirming the specific user's access to the requested item of information;
requesting from the specific user certain information relating to the purchased item of information;
receiving from the specific user, certain information relating to the purchased item of information;
generating assessment data based on the information received from the user;
storing the assessment data on a record server;
requesting from the specific user evaluation data relating to the purchased item of information;
receiving from the specific user, evaluation data relating to the purchased item of information;
storing the received evaluation data on an evaluation server;
storing on the record server, data relating to the specific user, the purchased item of information, and the specific user's access to the item of information; and
updating the specific user's account based on at least one of: the purchased item of information, the specific user's access to the item of information, the specific user's assessment data, and the specific user's evaluation data.

2. The method of claim 1, further comprising assigning cost data to each item of information.

3. The method of claim 2, further comprising storing the cost data on a pricing server.

4. The method of claim 2, further comprising linking an account balance to a user through the user's account.

5. The method of claim 4, further comprising debiting the account balance of a user based on a user's purchase of an item of information and the cost data for the purchased item.

6. The method of claim 1, wherein the user data comprises data relating to a first sponsor, and data relating to a second sponsor.

7. The method of claim 1, wherein the database of items of information stored on the content server is linked to evaluation information relating to the items of information stored on the evaluation server.

8. The method of claim 1, further comprising receiving items of information from users,.and storing the items of information on the content server.

9. The method of claim 8, further comprising providing a template for users to create items of information.

10. The method of claim 1, further comprising receiving a request from a user to provide selected user data to a remote server.

11. The method of claim 1, further comprising providing selected user data to a remote server.

12. The method of claim 1, further comprising receiving user data from a remote server.

13. The method of claim 1, wherein providing users access to a database of items of information stored on the content server that are available to that user, based on user data in the user's account comprises providing users a database of available content, searchable by at least one of: subject matter, author, certification, popularity, evaluation score, and cost.

14. The method of claim 1, further comprising providing at least one user access to a searchable database of items of information not stored on the content server.

15. A method of managing and storing items of information, including receiving items of information from a plurality of content providers, and distributing items of information to a plurality of users, comprising:
providing a content server;
identifying a plurality of content providers, remote from the content server;
creating an account for each content provider, including content provider data, on a pricing server;
receiving from at least one content provider, an item of information;
storing the received item of information on the content server;
updating the account for the specific content provider, including data relating to the received item of information;
identifying a plurality of users, remote from the content server;
creating an account for each user, including user data, on the pricing server;
providing each user access to a database of items of information stored on the content server that are available to that specific user, based on user data in the user's account;
receiving from at least one specific user, a request to purchase at least one item of information, the request including user data;
verifying the identity of the specific user based on user data included in the request;
verifying the specific user's entitlement to purchase the requested item of information;
providing access to the specific user, for a predetermined temporal period, to the purchased item of information;
confirming the specific user's access to the purchased item of information;
requesting from the specific user certain information relating to the purchased item of information;
receiving from the specific user certain information relating to the purchased item of information;
generating assessment data based on the information received from the user;
storing the assessment data on the record server;
requesting from the specific user evaluation data relating to the purchased item of information;
receiving from the specific user, evaluation data relating to the purchased item of information;
storing the received evaluation data on an evaluation server; and
updating the account of the specific user, including storing data relating to at least one of: the purchased item of information, the specific user's access to the item of information, the specific user's assessment data, the specific user's evaluation data.

16. A system for managing and storing items of information, including receiving items of information from a plurality of content providers, and distributing items of information to a plurality of users, comprising:
a record server, comprising data relating to users and content providers, including assessment data;
a content server, comprising items of information;
an evaluation server, comprising evaluation data received from users and content providers;
a pricing server, comprising data relating to the accounts of users and content providers, and data relating to the cost of the items of information;
wherein the servers are in data communication with one another, and are remote from both the content providers and the users; and
a system interface, physically remote from the servers and coupled to the servers by a network, configured to allow selected users and content providers to access the system, search the data of the record server, search the data of the content server, request and receive items of information, submit assessment data to the record server, submit evaluation data to the evaluation server, and upload items of information to the content server.

17. The system of claim 16, the system interface further comprising a conditional access system that allows selected users access to the system only after verification of certain user data in the user's account.

18. The system of claim 16, further comprising a data connection between the record server and an outside server.

19. The system of claim 18, wherein data is transmitted from the record server to the outside server.

20. The system of claim 16, further comprising a system administrator with data connections to the record server, the content server, the evaluation server and the pricing server.
